(19) United States
(12) Patent Application Publication
(10) Pub. No.: US 2016/0227309 A1
(43) Pub. Date: Aug. 4, 2016

(54) TANGLE-FREE EARPHONES

(71) Applicant: Rocco DeLeonardis, Paeonian Springs, VA (US)

(72) Inventor: Rocco DeLeonardis, Paeonian Springs, VA (US)

(21) Appl. No.: 15/025,889

(22) PCT Filed: Sep. 30, 2014
(86) PCT No.: PCT/US14/58482

§ 371 Date: Mar. 29, 2016

Related U.S. Application Data
(60) Provisional application No. 61/884,940, filed on Sep. 30, 2013.

(51) Int. Cl. H04R 1/10; H04R 1/08

(52) U.S. Cl. CPC H04R 1/1033; H04R 1/1016; H04R 1/1008; H04R 1/08

(57) ABSTRACT

A wired earphone device (1) is presented, having a reduced tendency to tangle. The earphone device (1) includes a plug (2) at a first end, connectable to an electrical device; a lead (3), having a plurality of wires (11, 12, 20) coupled to the plug, extends therefrom and connects the plug (2) to a first earbud (4). The lead extends from the first earbud (4) to a second earbud (6). The lead (3) extends between the plug (2) and the first and second earbuds (4,6) in a generally continuous manner.

### CROSS REFERENCE TO EARLIER APPLICATIONS

This application claims priority of U.S. provisional application 61884940, filed Sep. 30 2013, the entire contents of which is incorporated herein by reference.

### TECHNICAL FIELD

Embodiments relate to earphones. More specifically, the embodiments relate to wired earphones.

### BACKGROUND

A lead or cord is a long, slender, and flexible material that can take the form of many shapes and sizes, and be made of a large number of different materials. As used herein, lead encompasses cord, wire, string, cable and a multitude of other variations and materials. Some leads have one beginning and one end. One example of such a lead is an electric appliance cord that can be removed from the appliance. One end has a plug for insertion into an electric mains and the other end is inserted into a jack (either female or male) on the appliance.

Another example is a lead used for electronic earphones. Such earphone leads extend from an electronic device to a listener's ears, allowing the listener to hear audio. These cords have been used for decades. Such electronic devices serve a variety of purposes; examples include, but are not limited to, mobile telephones, tablet computers, MP3 players. Some users choose to listen to music while exercising, while others listen to an electronic device throughout the day no matter what the task.

In use, a listener inserts a male plug end of the headphone cord (e.g., a ⅛ in. male plug) into a corresponding female socket of the electronic device. After a certain length, the headphone cord splits into two separate cords, resulting in a “Y” configuration. These two ends are fitted with earphones that fit into or around a person's left and right ears. One example is the common earbud configuration. On some models, the earbud orientation is ear specific, whereas, in other models, the earbuds are interchangeable between the user's left and right ears.

One of the disadvantages regarding existing earphone technology is the likelihood of the cords becoming intertwined. Studies of tangling reveal that leads become tangled because loose ends are allowed to snake into loops of the cord or because loops are allowed to snake into other loops. When an end travels through a loop as the cord twists and turns, knots are created. When a user is not wearing the device, cord ends are unrestrained and free to move in any direction. While the headphones are stored, for instance, lying on a desk, in a drawer, or in a bag, to name a few, the free ends inevitably become intertwined and tangle. Once tangling occurs, a person is required to spend needless time and effort attempting to untangle the various ends. Moreover, once a person successfully untangles the earphone cords, there is nothing to prevent the cord ends from tangling yet again in the future. In addition, the tangling can result in knots, thereby creating kinks in the wires inside the cords and potentially damaging the operation of the headphones.

### SUMMARY

The present disclosure is directed to an earphone device having reduced tendency to tangle. According to one aspect, the earphone device includes a plug at a first end, connectable to an electrical device; a lead, having a plurality of wires coupled to the plug, extends therefrom and connects the plug to a first earbud. The lead extends from the first earbud to a second earbud. The lead extends between the plug and the first and second earphones in a generally continuous manner.

In one approach, the earphone device comprises a plug adapted to be connected to an electrical device; a lead, having a plurality of wires coupled to the plug, the plurality of electrical wires electrically interconnecting the plug and first earbud, and electrically interconnecting the plug and the second earbud. The lead has a first lead portion and a second lead portion, wherein said first lead portion extends from the plug to the first ear bud in a generally continuous manner and wherein said second lead portion extends from the first earbud to the second earbud in a generally continuous manner. The lead can be a single, continuous and branchless lead.

Attaching the plug to the first earbud using a single length of lead without branching therebetween and attaching the second earbud 6 to the first earbud 4 using a single length of lead without branching therebetween, provides a beneficial continuous configuration of the earphones which are substantially tangle free.

### BRIEF DESCRIPTION OF THE DRAWINGS

The following detailed description of the preferred embodiment of the present invention will be better understood when read in conjunction with the appended drawings. For the purpose of illustrating the invention, there are shown in the drawings embodiments which are presently preferred. It is understood, however, that the invention is not limited to the precise arrangements and instrumentalities shown. In the drawings:

FIG. 1A shows a first embodiment of the earphones worn by a user;

FIG. 1B shows a second embodiment of the earphones worn by a user;

FIG. 2A is an alternate view of the embodiment shown in FIG. 1A;

FIG. 2B is an alternate view of the embodiment shown in FIG. 1B;

FIG. 3 is a detail of an earbud according to a further embodiment;

FIG. 4 is a partial cross-sectional view of the earphones illustrating wires arranged in the lead according to one embodiment; and

FIG. 5 is a partial cross-sectional view of the earphones illustrating wires arranged in the lead according to another embodiment.

### DETAILED DESCRIPTION OF THE PREFERRED EMBODIMENTS

Certain terminology is used in the following description for convenience only and is not limiting. The words “right,” “left,” “top,” and “bottom” designate directions in the drawings to which reference is made. It should be understood that the term earphones herein describes in-ear as well as on-ear type earphones. The terms “headphone(s)” and “earphone(s)” are used herein interchangeably. As used herein, the term “earbud” can be used to describe both in-ear and on-ear types of earphone. The terms “cord” and “lead” are also used herein interchangeably. The words “a” and “one,” as used in the claims and in the corresponding portions of the specification, are defined as including one or more of the referenced item unless specifically stated otherwise. This terminology includes the words above specifically mentioned, derivatives thereof, and words of similar import. The phrase “at least one” followed by a list of two or more items, such as “A, B, or C,” means any individual one of A, B or C as well as any combination thereof.

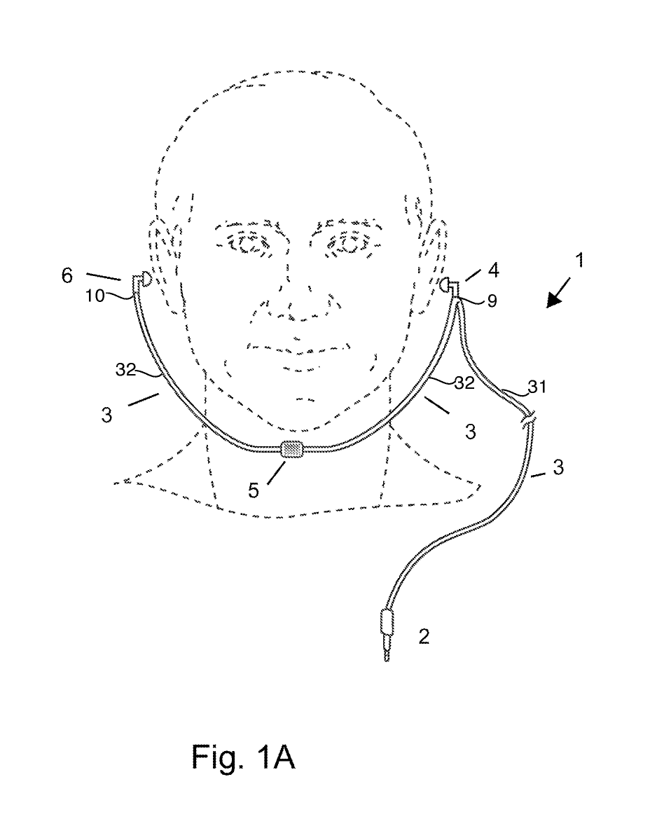

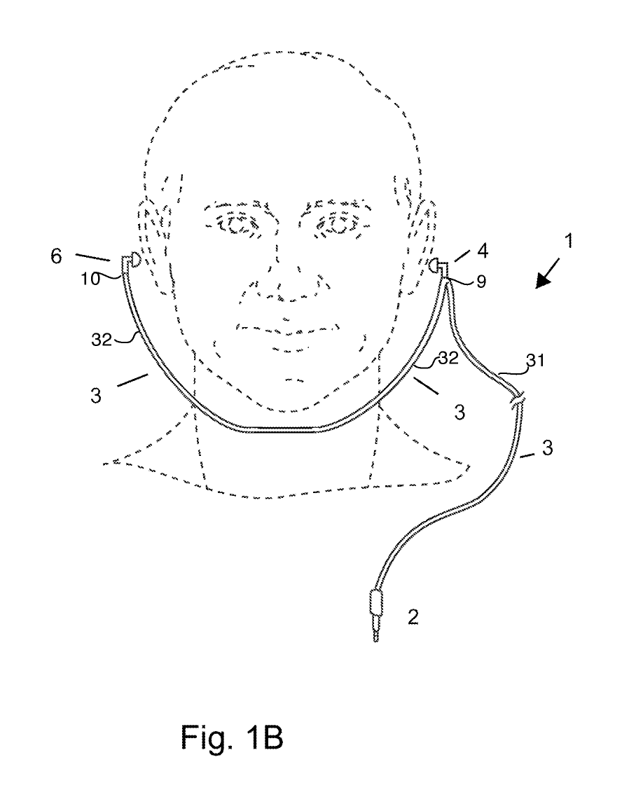

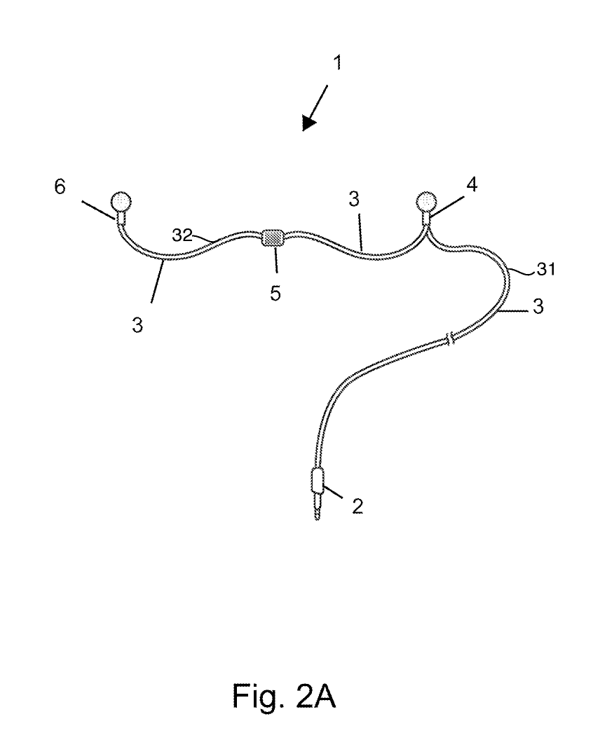

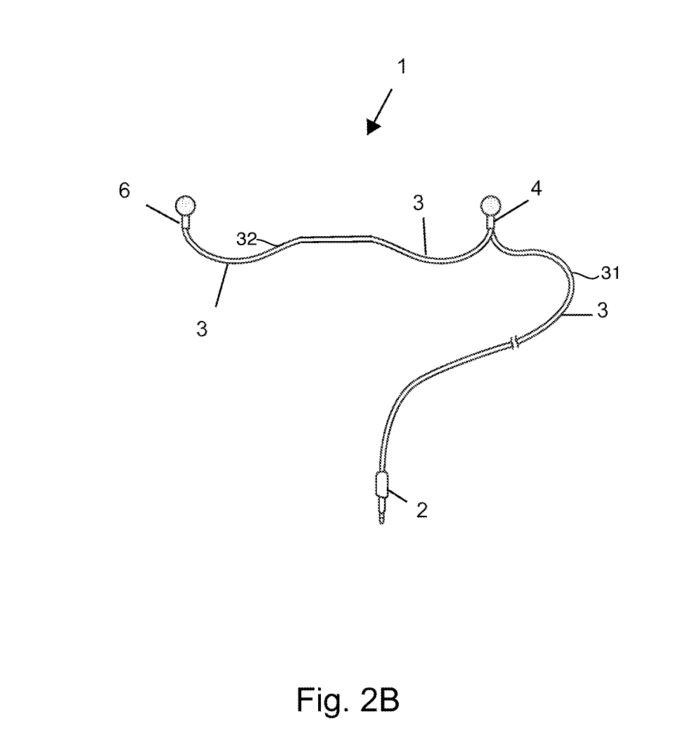

FIGS. 1A and 2A depict the tangle-free earphone device 1 according to one embodiment of the present invention. The earphone device 1 includes a plug 2, for connecting to an electrical (audio) device, e.g. telephones, computers, music players, etc., at a first end and a single lead 3 extending therefrom to a first earbud speaker or earbud 4 making a connection from the plug 2. The lead 3 extends from the first earbud 4 to a microphone 5 thereby connecting the plug 2, first earbud 4 and microphone 5. The microphone 5 can be a voice operated switch, known as VOX or Voice Operated exchange type microphone. This type of microphone is a switch that operates when sound over a certain threshold is detected, which can be used for communication or as a noise canceling input device where it samples ambient sounds and adjust the output to the earphones accordingly (e.g. with a telecommunication device). From the microphone 5, the lead 3 extends to the second earbud 6, connecting it to the microphone 5, plug 2 and first earbud 4. The microphone 5 can additionally include controls for providing access to the device, e.g. volume control, phone answering, track selection, etc. Lead 3 includes the wires necessary to make electrical connections between the plug 2 and earbuds 3,4 and microphone 5.

In the example of FIGS. 1A and 2A, lead 3 is a single continuous lead without any lead branching. By providing a single lead 3 that attaches the plug to the first earbud 4 and the first earbud 4 to the second earbud 4,6, a continuous configuration of the earphones 1 is provided resulting in a substantially tangle-free wired earphone device.

In the example of FIGS. 1A and 2A, the electrical connections (not shown) to the first earbud 4 pass through the side of the lead 3 attached to the first earbud 4. The electrical connections to the second earbud 6 pass through the lead end attached to the second earbud 6.

The earphone 1 of the embodiment shown in FIGS. 1B and 2B is arranged generally in the same manner, however does not include the microphone 5.

FIGS. 2A and 2B show the device 1 of FIGS. 1A and 1B, respectively, with the earbuds 4, 6 rotated 90 degrees from the depiction in FIGS. 1A and 1B.

As shown in the embodiments of FIGS. 1A & 2A and FIGS. 1B & 2B, lead 3 has a first lead portion 31 and a second lead portion 32. First lead portion 31 extends in a generally continuous manner from plug 2 to first earbud 4 and without any lead branching. Second lead portion 32 extends from first earbud 4 to second earbud 6 in a generally continuous manner and without any lead branching. In the embodiment of the accompanying drawings, each earbud 4,6 is an in-ear type of earphone. In other embodiments, earbuds 4,6 are earcups or other types of earphones that are configured to seat on or around the ears.

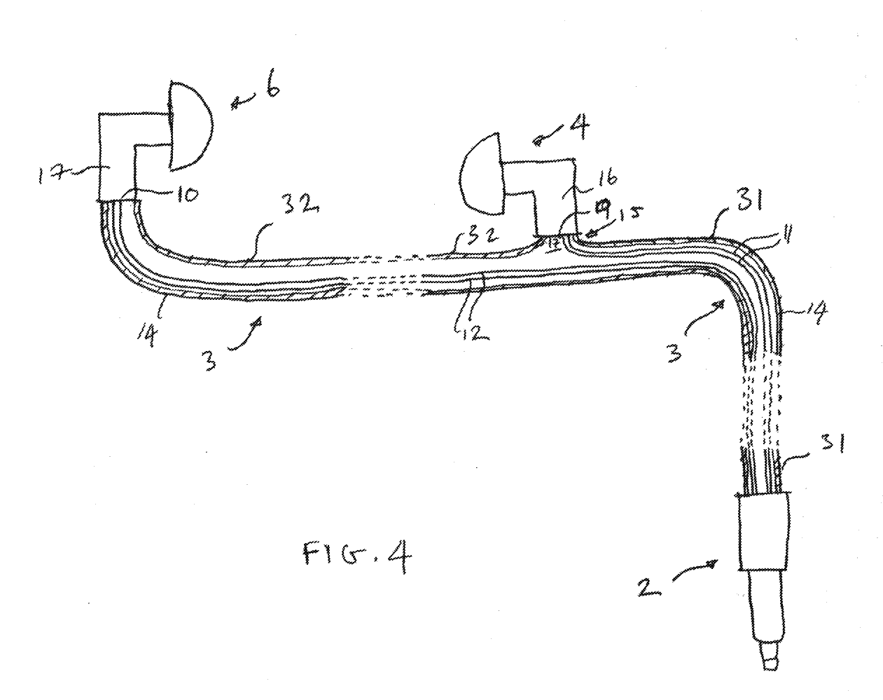

In the embodiments, branchless lead second portion 32 is coupled to the earbuds in a manner that allows lead second portion 32 to freely hang below the head of a user without unnecessarily obstructing movement of the users head or other body parts when the earphones are in use. For example, as shown in the embodiments of FIGS. 1A and 1B in conjunction with FIGS. 4 & 5, branchless lead second portion 32 has opposite physical connection points 9,10 where lead second portion 32 is physically coupled to first earbud 4 and second earbud 6, respectively. An end of lead 3, opposite the end connected to plug 2, serves as physical connection point 10. A sidewall portion 15 of lead casing 14 serves as connection point 9 (see FIGS. 4 & 5). In the embodiments of the figures, lead connection points 9,10 are fixedly coupled to the earbud housings 16, 17, respectively, at the earbud housing ends located away from the earbud diaphragms (see for example FIG. 4 for an enlarged view of the earbuds 4,6). However, in other embodiments, the lead connection points may be coupled to other positions on the earbud housing. The length of lead second portion 32 between opposite connection points 9,10 is freely supported at the connection points by first earbud 4 and second earbud 6. Lead casing 14 is any flexible insulating casing utilized or suitable for use in headphone leads, such as but not limited to a rubber casing.

As already mentioned above, lead 3 includes a plurality of conductive wires, such as copper or the like, for electrically connecting the earbuds 4,6 to plug 2. Different wiring arrangements in lead 3 are envisaged. For example, FIG. 4 is a partial cross sectional view of the lead of FIG. 1B showing an electrical wiring arrangement therein according to one embodiment. A plurality of electrically conductive wires 11, 12, are carried inside lead casing 14. Conductive wires 11 are a first set of wires, typically a pair of wires comprising a ground wire and signal wire, electrically connecting plug 2 to first earbud 4. Conductive wires 12 are a second set of wires, typically a pair of wires comprising a ground wire and a signal wire, electrically connecting plug 2 to the second earbud 6. The arrangement of wiring within plug 2 is the same as for known earphone device plugs.

As shown in FIG. 4, each wire 11 of the first set of wires extends from plug 2 into lead 3 within casing 14, then through lead sidewall portion 15 and into first earbud housing 16 to electrical connect to the diaphragm of first ear bud 4. The arrangement of wiring to the speaker within the earbud housing is the same as for known earphone devices. As best shown in FIG. 4, sidewall portion 15 of lead casing 14 is disposed contiguous or in close proximity with first earbud 4 and has an opening 17 through which each wire 11 extends from inside lead casing 14 to first earbud 4.

In some embodiments, first set of wires 11 is a first set of single continuous wires without any wire branching within first lead portion 31. Additionally, in some embodiments, second set of conductive wires 12 is a set of single continuous wires without any wire branching in lead 3 and extending inside lead casing 14 from plug 2 without interruption directly to second earbud 6 as shown in FIG. 4.

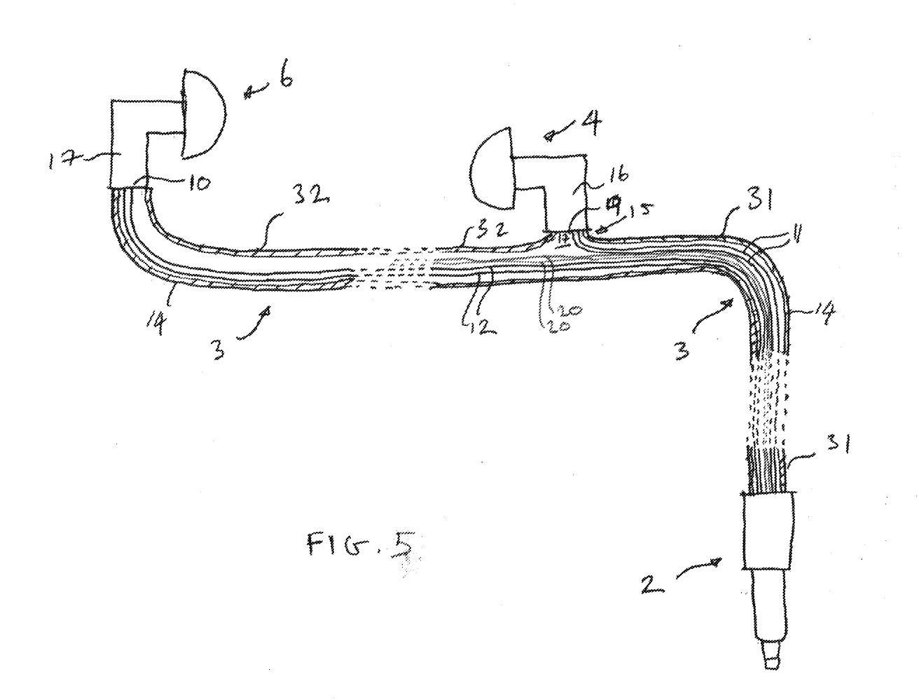

Embodiments of the earphones with the microphone shown in FIG. 1A also have lead wiring arrangements as shown and described hereinbefore with reference to FIG. 4. However, a third set of wires 20 are also included such as for example shown in FIG. 5 which is a partial cross-sectional view of the lead 3 of FIG. 1A. The third set of wires 20 is typically a pair of wires comprising a ground wire and a signal wire, electrically connecting plug 2 to the microphone (note the microphone is not shown in FIG. 5 for sake of clarity)

Other types of wiring arrangements within lead 3 are envisaged. For example, in other embodiments, the wire arrangement of the second set of wires 12 is modified such that each wire extends through the lead from plug 2 into first ear bud 4 and then from first earbud 4 further through second lead portion 32 to electrically connect with second earbud 6.

In some other embodiments of the device, lead portions 31 and 32 are separate branchless leads that together form lead 3 and that are each physically coupled at one end to earbud 4. The wiring arrangement is the same as the wiring arrangement of FIGS. 4 & 5 except that the electrical connections extending beyond the first earbud 4, such as for example second set of wires 12 (and third set of wires 20 where the microphone is included), pass through both lead ends attached to first earbud 4. The electrical connections to both earbud 4 and earbud 6 pass out of the end of a first lead attached to first earbud 4 and electrical connections to earbud 6 further pass into the end of a second lead attached to the first earbud 4 and out of the other end of second lead attached to earbud 6.

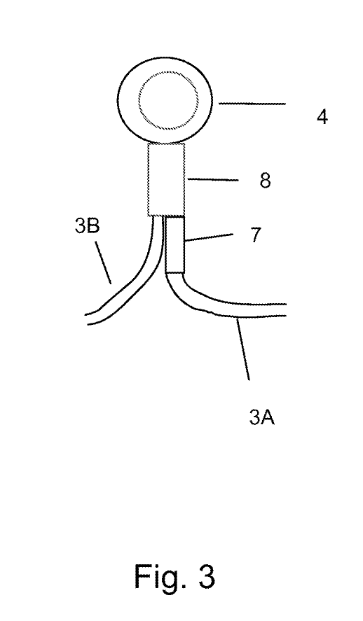

By way of non-limiting example of such other embodiments of the device in which first and second lead portions are each individual leads, reference will now be made to an embodiment shown in FIG. 3. In the embodiment shown in FIG. 3 with or without an auxiliary plug, the lead 3 may not be continuous and may comprise a first lead 3A extending between first earbud 4 and plug 2, and a second lead 3B extending between the first earbud 4 and the second earbud 6. Each of the first and second leads 3A, 3B are branchless leads. In such an example, the first lead 3A has one end attached to the plug 2 and an opposite end attached to the first earbud 4. The second lead 3B has one end attached to the first earbud 4 and an opposite end attached to the second earbud 6 (see for example FIG. 3). The electrical connection to the first earbud 4 passes through the end of the first lead 3A attached to the first earbud 4. The electrical connection to the second earbud 6 passes from plug 2 through the first lead 3A attached to the first earbud 4, on through the second lead attached to the first earbud 4, and further on through the second lead end attached to the second earbud 6.

In the examples in which first and second leads 3A and 3B are used, second lead 3B is a single continuous lead attaching the first earbud 4 to the second earbud 6 without any lead branching. By providing a single branchless lead 3A that attaches the plug 2 to the first earbud 4 and a single branchless lead 3B that attaches the first earbud 4 to the second earbud 6, a continuous configuration of the earphones 1 is provided resulting in a substantially tangle-free wired earphone device.

In the non-limiting example of FIG. 3, the first earbud 4 has a portion 8 configured to receive an auxiliary plug 7, for example but not limited to a ⅛ inch type plug, which allows the lead 3A to be replaced if necessary. Such an arrangement allows for interchanging of the lead cable to allow the earphones 1 to be used with different features, e.g. controllers, musical device interfaces, secondary audio sources, etc. The arrangement of the embodiment of FIG. 3 also allow the auxiliary plug 7 to be disconnected from the connection portion 8 of the first earbud 4 instead of pulling the earphones 4, 6 from a user's ears should the lead become caught on something. Further, the arrangement of FIG. 3 allows the earphones 1 to be used with different sized jacks, providing greater flexibility. In another embodiment, the first earbud 4 has connection portion 8 configured to receive an auxiliary plug 7 on the end of lead 3B instead of, or in addition to, the auxiliary plug on the end of lead 3A. Such an arrangement allows the auxiliary plug 7 on the lead 3B to be disconnected from the connection portion 8 on the first earbud 4. The second earbud 6 and lead 3B can then be stored away for later use leaving the first earbud 4 and lead 3A to serve as a single earbud earphone device.

As indicated hereinbefore, attaching the plug 2 to the first earbud 4 using a single length of lead without branching therebetween and attaching the second earbud 6 to the first earbud 4 using a single length of lead without branching therebetween, provides the beneficial continuous configuration of the earphones 1.

When not in use the continuous configuration of the earphones 1 provides easy, tangle-free storage. To store, for example, the first earbud 4 is grasped between the user's thumb and forefinger the plug 2 and second earbud 6 and can be coiled about first earbud 4. Alternatively the plug to can be grasped and the entire lead can be wrapped around the users fingers for easy storage.

As a result of the arrangement of the present invention, the lead 3 used to connect the plug to the first earbud 4 to the microphone 5 and the second earbud 6 can be of a continuous dimension. The dimension, as a result, is substantial enough to resist tangling since all of the leads 3 are of the same substantial thickness. Further, the arrangement as described herein due to the continuous arrangement, eliminates branching of the leads to the individual earphones, when compared to the conventional Y shaped arrangement, and which greatly reduces tangling when storing or using the earphones 1 of the present device.

The earbuds shown in the accompany figures are just an example of one type of ear bud and the positioning of those ear buds on the earphone wire. In other embodiments, earbuds 4, 6 may be earcups, earspeakers, or any other type of earphones that are configured to seat on or around the ear, or any other small loudspeakers that are designed to be held in place dose to a user's ears.

It is understood, therefore, that this invention is not limited to the particular embodiments disclosed, but is intended to cover all modifications which are within the spirit and scope of the invention as defined by the appended claims; the above description; and/or shown in the attached drawings.

1. An earphone device comprising a plug adapted to be connected to an electrical device; a lead, having a plurality of wires coupled to the plug and connecting the plug to a first earbud, the lead extending from the first earbud to a second earbud, wherein the lead extends between the plug and the first and second earbuds in a generally continuous manner.

2. The earphone device of claim 1, further comprising a microphone disposed in between and continuous with the first and second earbuds.

3. The earphone device of claim 1, wherein the first earbud comprises a portion configured to receive and make an electrical connection with a second plug connected from the lead that extends from the plug, the second plug being detachable from the first earbud.

4. An earphone device comprising a plug adapted to be connected to an electrical device; a lead, having a plurality of wires coupled to the plug, said plurality of electrical wires electrically interconnecting the plug and a first earbud and electrically interconnecting the plug and the second earbud, wherein said lead has a first lead portion and a second lead portion, wherein said first lead portion extends from the plug to the first ear bud in a generally continuous manner and wherein said second lead portion extends from the first earbud to the second earbud in a generally continuous manner.

5. The earphone device of claim 4, wherein said lead is a single, continuous and branchless lead.

6. The earphone device of claim 4, wherein said first lead portion is a first single, continuous and branchless lead.

7. The earphone device of claim 4, wherein said second lead portion is a second single, continuous and branchless lead.

8. The earphone device of claim 4, wherein said lead second portion has opposite physical connection points coupled to said first earbud and said second bud, respectively, and wherein a length of said lead second portion is freely supported at said opposite connection points by said first earbud and said second earbud.

9. The earphone device of claim 8, wherein said lead is a single, continuous and branchless lead.

10. The earphone device of claim 4, wherein said lead has an insulating casing, said lead insulating casing carrying therein said plurality of wires, wherein said plurality of wires comprises a first set of electrically conductive wires and a second set of electrically conductive wires, wherein each one of said first set of conductive wires electrically interconnect the first earbud and plug; and wherein each one of said second set of conductive wires electrically interconnect the second earbud and the plug.

11. The earphone device of claim 10, wherein said lead is a single, continuous and branchless lead; and wherein each one of said first set of conductive wires and/or each one of said second set of conductive wires is a single continuous wire without any wire branching inside said lead casing.

12. The earphone device of claim 10, wherein a sidewall portion of said lead casing is disposed contiguous or in close proximity with said first earbud, wherein said first set of conductive wires carried inside said insulating casing extend from said plug, into said lead casing, through said lead sidewall portion to said first ear bud.

13. The earphone device of claim 12, wherein each one of said second set of conductive wires is a single continuous wire without any wire branching inside said lead casing and wherein said second set of conductive wires extends into said lead casing from said plug and without interruption directly to said second earbud.

14. The earphone device of claim 4, further comprising a microphone disposed in between and continuous with the first and second earbuds.

15. An earphone device comprising a plug adapted to be connected to an electrical device; a lead, having a plurality of wires coupled to the plug, said plurality of electrical wires electrically interconnecting the plug and a first earbud and electrically interconnecting the plug and the second earbud, wherein said lead is a single, continuous and branchless lead and wherein said lead has a first lead portion and a second lead portion, wherein said first lead portion extends from the plug to the first ear bud in a generally continuous manner and wherein said second lead portion extends from the first earbud to the second earbud in a generally continuous manner.

16. The earphone device of claim 15, wherein said lead second portion has opposite connection points physically coupled to said first earbud and said second earbud, respectively, and wherein a length of said lead second portion extending from one of said connection points to the other of said connection points is freely supported at said connection points by said first earbud and said second earbud.

17. The earphone device of claim 16, wherein said lead has an insulating casing, said lead insulating casing carrying therein said plurality of wires, wherein said plurality of wires comprises a first set of electrically conductive wires and a second set of electrically conductive wires, wherein said each one of said first set of conductive wires electrically interconnect the first earbud and plug; and wherein each one of said second set of conductive wires electrically interconnect the second earbud and the plug.

18. The earphone device of claim 17, wherein a sidewall portion of said lead casing is disposed contiguous or in close proximity with said first earbud, wherein said first set of conductive wires carried inside said insulating casing extends from inside said lead casing through an opening in said sidewall portion to said first ear bud.

19. The earphone device of claim 18, wherein each one of said second set of conductive wires is a single continuous wire without any wire branching inside said lead casing.

20. The earphone device of claim 17, further comprising a microphone disposed in between and continuous with the first and second earbuds; and a third set of conductive wires extending from said plug to said microphone.

21. The earphone device of claim 1, wherein the earbuds are in-ear earphones.

22. The earphone device of claim 1, wherein the earbuds are earcup earphones.

23. (canceled)
